(19) United States
(12) Patent Application Publication
(10) Pub. No.: US 2015/0035879 A1
(43) Pub. Date: Feb. 5, 2015

(54) METHOD AND APPARATUS FOR MEASURING CAPACITANCE OF ORGANIC LIGHT-EMITTING DEVICE

(71) Applicant: Samsung Display Co., Ltd., Yongin-City (KR)

(72) Inventors: Tae-Kyu SHIM, Yongin-City (KR); Myung-Hwan KIM, Yongin-City (KR); Won-Jun SONG, Yongin-City (KR); Kwan-Hee LEE, Yongin-City (KR)

(73) Assignee: Samsung Display Co., Ltd., Yongin-City (KR)

(21) Appl. No.: 14/269,404

(22) Filed: May 5, 2014

(30) Foreign Application Priority Data
Aug. 2, 2013 (KR) 10-2013-0092241

(51) Int. Cl. G09G 3/00; G09G 3/32

(52) U.S. Cl. CPC G09G 3/006; G09G 3/3258
USPC 345/694; 345/204; 345/211; 345/77

(57) ABSTRACT

An apparatus measures capacitance of an organic light-emitting device in a display panel, which includes at least one pixel having the organic light-emitting device. The apparatus includes a panel driver, an impedance analyzer, and a panel jig. The panel driver drives the pixel. The impedance analyzer measures capacitance of the organic light-emitting device. The panel jig connects the display panel, panel driver, and impedance analyzer.

### CROSS-REFERENCE TO RELATED APPLICATION

Korean Patent Application No. 10-2013-0092241, filed on Aug. 2, 2013, and entitled, “Method and Apparatus For Measuring Capacitance Of Organic Light-Emitting Device,” is incorporated by reference herein in its entirety.

### BACKGROUND

1. Field

One or more embodiments described herein relate to a display device.

2. Description of the Related Art

An organic light-emitting device of an organic light-emitting display is formed from an organic emission layer between hole and electron injection electrodes. When holes from the hole injection electrode and electrons from the electron injection electrode combine in the organic emission layer, excitons are generated. Light is emitted when the excitons pass from an excited state to a ground state.

Organic light-emitting displays operate at lower voltages, are thinner and lighter in weight, and have wider viewing angles, faster response speeds, and higher contrast than other types of displays. Organic light-emitting displays are self-emitting devices, which mean that they do not require a separate light (e.g., backlight) source.

### SUMMARY

In accordance with one embodiment, an apparatus for measuring capacitance of an organic light-emitting device of a display panel having at least one pixel including the organic light-emitting device, the apparatus comprising a panel driver to drive the pixel; an impedance analyzer to measure capacitance of the organic light-emitting device; and a panel jig to connect the display panel, panel driver, and impedance analyzer.

The panel jig may include a panel driver connection unit electrically connected to the panel driver; a flexible printed circuit board electrically connected to a pad electrode of the display panel; and a first terminal and a second terminal connected to the impedance analyzer.

The organic light-emitting device may include a first electrode, an intermediate layer, and a second electrode, and wherein the first terminal is electrically connected to the first electrode and second terminal is electrically connected to the second electrode.

The pixel may include a pixel driver and the organic light-emitting device, and the pixel driver may include at least one thin film transistor. The panel driver may include a power driver to provide a high potential voltage and a low potential voltage to the display panel; a data driver to provide a data voltage to the pixel; and a gate driver to provide a gate signal to the pixel.

The panel driver may drive the pixels individually or in groups. The panel driver may select and drive only pixels that emit a same color. A data voltage may be provided by the panel driver is lower than a saturation voltage of a thin film transistor in the pixel. The impedance analyzer may measure capacitance by simultaneously applying a direct current (DC) measurement voltage and an alternating current (AC) signal.

The apparatus may include a temperature control chamber that surrounds the display panel, wherein the temperature control chamber is to control a temperature of the display panel. The panel jig may include a temperature control unit to control a temperature of the display panel. The temperature control unit includes at least one Peltier device.

In accordance with another embodiment, an apparatus for measuring capacitance of an organic light-emitting device in a display panel including a plurality of pixels, the apparatus comprising a panel driver to individually drive the pixels; an impedance analyzer to measure capacitance of at least one of the pixels; and a panel jig to connect the display panel, the panel driver, and the impedance analyzer.

The pixel may include a pixel driver and an organic light-emitting device, and a cathode terminal and an anode terminal of the organic light-emitting device are connected to the impedance analyzer through the panel jig and a wiring unit of the display panel. A first measurement line may be connected to the cathode terminal, and the first measurement line may provide a predetermined voltage to the pixel.

In accordance with another embodiment, a method of measuring capacitance of an organic light-emitting device in a display panel including a panel driver to drive the pixels, the method including providing an apparatus including an impedance analyzer to measure capacitance of an organic light-emitting device in at least one of the pixels, and a panel jig to connect the display panel, panel driver, and impedance analyzer, the method comprising connecting the display panel, panel driver, impedance analyzer, and panel jig; and measuring capacitance of the organic light-emitting device by driving the impedance analyzer.

Measuring the capacitance of the organic light-emitting device may include applying an alternating current (AC) signal while changing a direct current (DC) measurement voltage. A data voltage provided by the panel driver may be lower than a saturation voltage of a thin film transistor in the pixel.

The capacitance may be measured by selecting only pixels that emit a same color. The apparatus may further include a temperature control chamber, and measuring the capacitance of the organic light-emitting device may include changing a temperature of a temperature control chamber in which at least one pixel is included.

### BRIEF DESCRIPTION OF THE DRAWINGS

Features will become apparent to those of skill in the art by describing in detail exemplary embodiments with reference to the attached drawings in which:

FIG. 1 illustrates an embodiment of a capacitance measuring apparatus;

FIG. 2 illustrates an example of a pixel in a display panel;

FIG. 3 illustrates an embodiment of a pixel;

FIG. 4 illustrates an enlarged view of portion F in FIG. 3;

FIG. 5 illustrates an example of a panel driver;

FIG. 6 illustrates an embodiment of a capacitance measuring method;

FIG. 7 illustrates an example of capacitance corresponding to a direct current (DC) measurement voltage;

FIG. 8 illustrates another embodiment of capacitance measuring apparatus;

FIG. 9 illustrates another embodiment of capacitance measuring apparatus; and

FIG. 10 illustrates a plan view illustrating a panel jig in FIG. 9.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

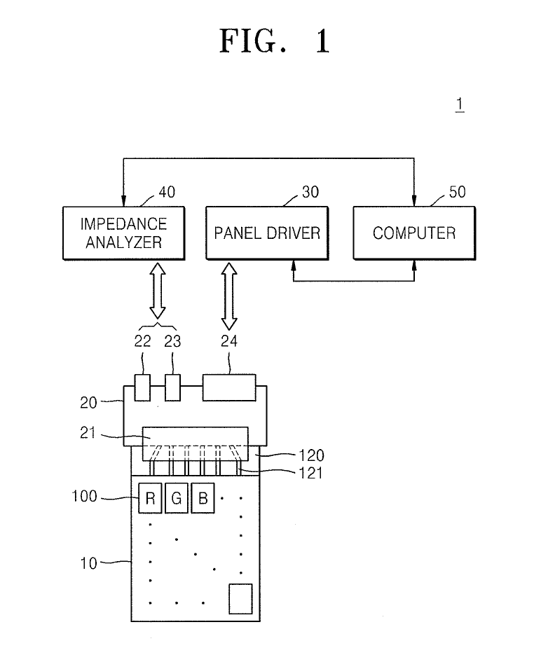

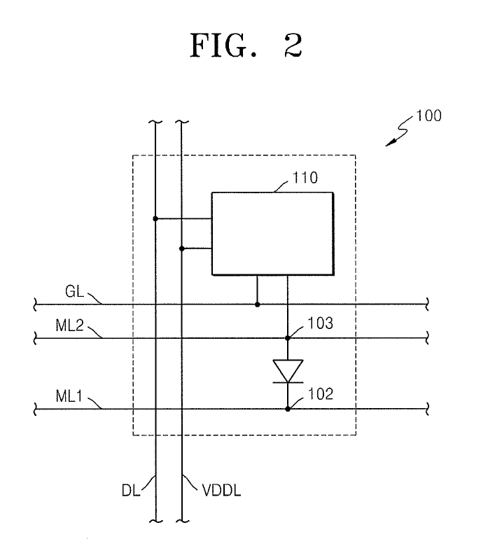

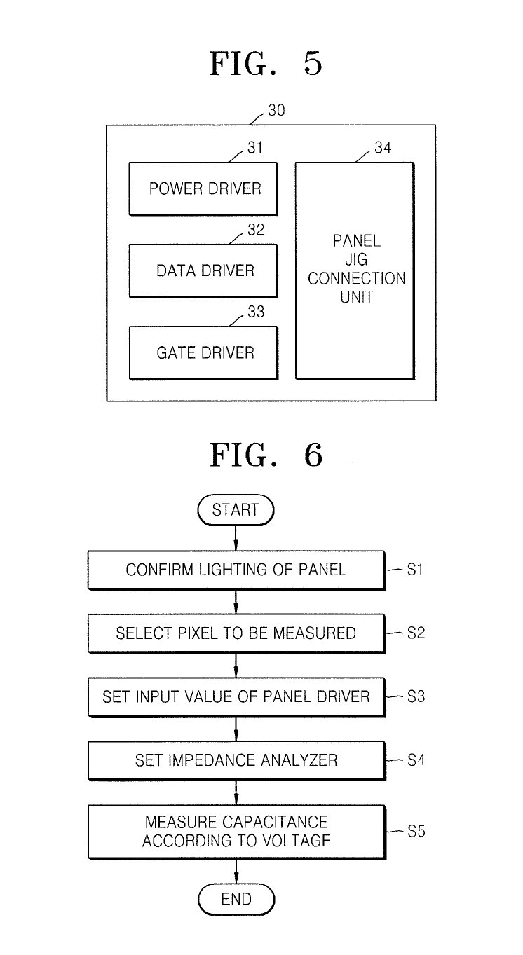

FIG. 1 illustrates an embodiment of an apparatus 1 for measuring capacitance of an organic light-emitting device. FIG. 2 illustrates an equivalent circuit diagram of a pixel 100 in a display panel 10. FIG. 5 illustrates a configuration of a panel driver 30.

Referring to FIGS. 1 and 2, apparatus 1 includes a display panel 10, a panel jig 20, panel driver 30, and impedance analyzer 40 coupled to a display panel 10. The apparatus 1 may further include a computer 50 (or other type of processor or controller) for processing measured data.

The display panel 10 includes a display unit with pixels 100 of an organic light-emitting device. A wiring unit 120 is coupled to the display panel 10. Each of the pixels 100 may emit red R, green G, blue B, or white W light. As a result, the display panel 10 may display various color images.

Also, the pixels 100 may be arranged in various ways, for example, in a stripe structure or a PenTile structure. In a stripe structure, pixels having the same color are arranged in a column. In a PenTile structure, red pixels and blue pixels are alternately arranged in a same column and green pixels are arranged in an adjacent column. The pixels may be arranged in other ways in alternative embodiments.

Each pixel 100 includes a pixel driver 110 to drive an organic light-emitting device (OLED). The pixel driver 110 is connected to a power supply line (VDDL), a gate line GL to carry gate signals, and a data line DL to carry data voltages. The pixel driver 110 may include a plurality of thin film transistors and one or more capacitors. The transistors may control the brightness of light to be emitted by the pixel 100, for example, by adjusting an amount of current flowing in the OLED based on a data voltage provided from a corresponding data line DL.

The OLED has electrodes connected to respective ones of a first measurement line ML1 and a second measurement line ML2. For example, ML1 may be connected to a cathode terminal 102 of the OLED, and ML2 may be connected to an anode terminal 103. The measurement lines ML1 and the ML2 may be connected to the impedance analyzer 40 through the panel jig 20. As a result, capacitance of the OLED in the pixel 100 may be measured. In one embodiment, the first measurement line ML1 may provide a low potential voltage (VSS) to the OLED.

The wiring unit 120 may include a pad electrode 121, to allow for connection of various wirings (e.g., VDDL, DL, GL, ML1, and/or ML2) between pixel 100 and one or more external devices.

The panel driver 30 drives the display panel 10. As illustrated in FIG. 5, the panel driver 30 may include a power driver 31, a data driver 32, a gate driver 33, and a panel jig connection unit 34. The power driver 31 may respectively supply a high potential voltage (VDD) and the lower potential voltage VSS, which are to be applied to pixel 100, to the VDDL and ML2. The data driver 32 may supply a data voltage to the data line DL. The gate driver 33 may supply a gate signal to the gate line GL.

The panel driver 30 may drive the plurality of pixels 100 individually or in groups. In some embodiments, the panel driver 30 may drive only pixels emitting red R light in groups. In some embodiments, the panel driver 30 may drive only several pixels disposed in a predetermined region in groups.

The panel driver 30 may set the VDD, VSS, data voltage, and gate signal so that a pixel circuit unit is not affected during the measurement of the capacitance of the OLED. In some embodiments, the data voltage may be lower than a saturation voltage of a driving thin film transistor of the pixel driver 110.

The panel jig connection unit 34 may electrically connect the panel driver 30 and the panel jig 20. The panel jig connection unit 34 and a panel driver connection unit 24 of the panel jig 20 may be connected with a cable.

The panel jig 20 may include a flexible printed circuit board 21 electrically connected to pad electrode 121 of display panel 10. A first terminal 22 and a second terminal 23 are respectively connected to the first and second measurement lines ML1 and the ML2. Also, the panel jig 20 includes panel driver connection unit 24 electrically connected to panel driver 30. The panel jig 20 may further include an external power supply terminal that may supply the VDD.

The flexible printed circuit board 21 may be disposed on the panel electrode 121 and fixed to the panel jig 20. The flexible printed circuit board 21 may have a certain desired flexibility and may be attached to the wiring unit 120 of the display panel 10. As a result, pad electrode 121 and flexible printed circuit board 21 may be electrically connected to each other.

The flexible printed circuit board 21 may supply various signals from the panel driver 30 to the pixel driver 110 and OLED. The flexible printed circuit board 21 may transmit a signal for measuring the capacitance of the OLED to the impedance analyzer 40, through first terminal 22 and second terminal 23. The first terminal 22 and second terminal 23 may be respectively connected to a (−) measurement terminal and a (+) measurement terminal of the impedance analyzer 40.

The first terminal 22 may be electrically connected to the first measurement line ML1 of the OLED through the flexible printed circuit board 21. As a result, the first terminal 22 may be electrically connected to the cathode terminal 102 of the OLED. The second terminal 23 may be electrically connected to the second measurement line ML2 of the OLED through the flexible printed circuit board 21. As a result, the second terminal 23 may be electrically connected to the anode terminal 103 of the OLED. That is, the cathode terminal 102 and anode terminal 103 of the OLED may be connected to impedance analyzer 40 through wiring unit 120 of the display panel 10 and panel jig 20.

Thus, the first terminal 22 and second terminal 23 are internally connected to the OLED through the flexible printed circuit board 21, and are externally connected to the impedance analyzer 40. The first terminal 22 and second terminal 23 provide a measurement voltage and an alternating current (AC) frequency from the impedance analyzer 40 to the OLED. The first and second terminals 22 and 23 may transmit a measurement signal to the impedance analyzer 40.

In one embodiment, the impedance analyzer 40 applies a direct current (DC) measurement voltage between the cathode terminal 102 and anode terminal 103 of the OLED through the first terminal 22 and the second terminal 23. The impedance analyzer 40 may measure the capacitance of the OLED by superimposing AC signals having predetermined amplitude and frequency.

In some embodiments, the DC measurement voltage may be changed from about −50 V to about +50V. In some embodiments, the frequency of the AC signal may be a frequency selected in a predetermined range, for example, between about 10 Hz and about 1 GHz.

The computer 50 is connected to the impedance analyzer 40 and/or panel driver 30. The computer 50 may set the DC measurement voltage and the AC signal of the impedance analyzer 40, and may process data measured by the impedance analyzer 40. Also, the computer 50 may set various signal values of the panel driver 30.

As described above, the apparatus 1 for measuring capacitance of an organic light-emitting device may individually or selectively measure capacitance of the OLED according to the set values of the panel driver 30 in a state of the display panel 10. As a result, the apparatus 1 may easily measure and/or evaluate characteristics of the OLED in the state of the display panel 10.

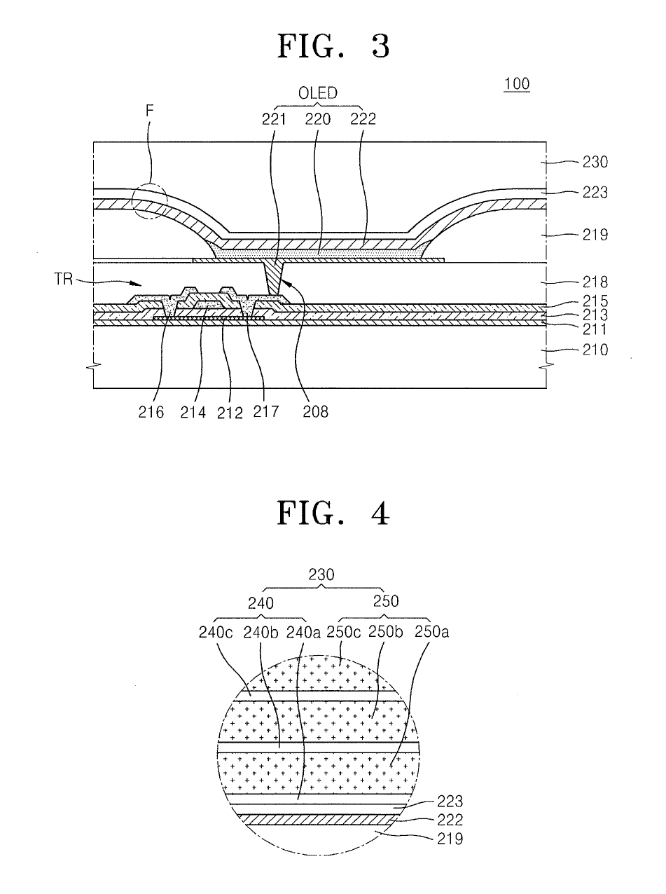

FIG. 3 illustrates a cross-sectional view of one embodiment of pixel 100, and FIG. 4 illustrates an enlarged view of portion F of FIG. 3. In FIGS. 3 and 4, the OLED and one or more thin film transistor may be formed on a substrate 210. The substrate 210 may be formed, for example, of a glass material, a plastic material, or a metallic material. The substrate 210 may be a flexible substrate.

A buffer layer 211 may be formed on the substrate 210. The buffer layer 211 may include an insulating material, in order to provide a flat surface on the substrate 210 and to prevent moisture and foreign matter from reaching the substrate 210. A thin film transistor TR, a capacitor, and an OLED may be formed on the buffer layer 211. The transistor TR may broadly include an active layer 212, a gate electrode 214, a source electrode 216, and a drain electrode 217.

The OLED may include an intermediate layer 220 between a first electrode 221 and a second electrode 222. The first electrode 221 may be an anode. In this case, the first electrode 221 may be electrically connected to the anode terminal 103 of FIG. 2. As a result, the first electrode 221 may be electrically connected to the first terminal 22 of the panel jig 20.

The second electrode 222 may be a cathode. In this case, the second electrode 222 may be electrically connected to the cathode terminal 102 of FIG. 2. As a result, the second electrode 222 may be electrically connected to the second terminal 23 of the panel jig 20.

Specifically, the active layer 212 may be disposed in a predetermined pattern on the buffer layer 211. The active layer 212 may include various materials. For example, the active layer 212 may include an inorganic semiconductor material such as amorphous silicon or polysilicon. According to another example, the active layer 212 may include an oxide semiconductor. According to another example, the active layer 212 may include an organic semiconductor material.

A gate dielectric layer 213 may be formed on the active layer 212. The gate electrode 214 may be formed on the gate dielectric layer 214 to correspond to the active layer 212.

An interlayer dielectric 215 is formed to cover the gate electrode 214. The source electrode 216 and drain electrode 217 are formed on the interlayer dielectric 215. The source electrode 216 and drain electrode 217 may be in contact with predetermined regions of the active layer 212.

A planarization layer 218 is formed to cover the source electrode 216 and the drain electrode 217. A separate insulating layer may be formed on the planarization layer 218.

The first electrode 221 may be formed on the planarization layer 218. The first electrode 221 may be formed to be electrically connected to one of the source electrode 216 or the drain electrode 217 through a via hole 208.

A pixel-defining layer 219 may be formed to cover the first electrode 221. A predetermined opening is formed in the pixel-defining layer 219. The intermediate layer 220, which includes an organic emission layer, may be formed in a region adjacent and/or limited to the opening. The pixel-defining layer 219 defines a pixel region and a non-pixel region. That is, the opening of the pixel-defining layer 219 becomes the substantial pixel region.

The intermediate layer 220 includes the organic emission layer. According to another example, the intermediate layer 220 includes the organic emission layer and may further include at least one of a hole injection layer (HIL), a hole transport layer (HTL), an electron transport layer (ETL), or an electron injection layer (EIL). Alternatively, the intermediate layer 220 may include the organic emission layer and one or more additional functional layers.

The second electrode 222 may be formed on the intermediate layer 220. The first electrode 221 may be patterned for each pixel. The second electrode 222 may be formed to allow a common voltage to be applied to all pixels.

Although only a single OLED is illustrated in FIG. 3, the display panel 10 may include a plurality of OLEDs. A single pixel may be formed for each OLED. Each pixel may generate, for example, a red, green, blue, or white color.

The intermediate layer 220 may be commonly formed on the entire planarization layer 218, regardless of a position of the pixel. The organic emission layer, for example, may be formed by vertically stacking or mixing layers including light-emitting materials that emit red, green, and/or blue light. If the organic emission layer emits white light, a combination of different colors may be possible. Also, a color conversion layer for converting the emitted white light into a predetermined color, or a color filter, may be further included.

A protection layer 223 may be disposed on the OLED and the pixel-defining layer 219. The protection layer 223 may cover and thus protect the OLED. The protection layer 223 may include an inorganic insulating layer and/or an organic insulating layer.

An encapsulation layer 230 may prevent moisture or oxygen from penetrating into the OLED and/or the TR. The encapsulation layer 230 may include an inorganic layer 240 and/or an organic layer 250. The inorganic layer 240 may include a plurality of inorganic layers 240a, 240b, and 240c, and the organic layer 250 may include a plurality of organic layers 250a, 250b, and 250c. Although FIG. 4 illustrates one type of structure, in which the inorganic layer 240 and the organic layer 250 are alternately stacked, the encapsulation layer 230 may have a different structure in other embodiments. For example, the encapsulation layer 230 may be a single layer or a stacked layer. In some embodiments, the encapsulation layer 230 may include a low melting glass material including tin oxide.

FIG. 6 illustrates one embodiment of a method of measuring capacitance of an organic light-emitting device in the state of the display panel 10. In an initial operation, the display panel 10 is connected and fixed to the panel jig 20, for example, as in FIG. 1. In this case, the flexible printed circuit board 21 and wiring unit 120 of display panel 10 may be joined together to provide signals to the VDDL, DL, and GL lines.

Next, the panel driver connection unit 24 of the panel jig 20 and the panel jig connection unit 34 of the panel driver 30 are connected with a cable or other type of signal line or connection. The panel driver 30 and computer 50, and the impedance analyzer 40 and computer 50 are connected. Then, default values for measuring capacitance are set.

Thereafter, in operation S1, various voltage values for lighting the display panel 10 are set in the panel driver 30. The lighting of the display panel 10 by the voltage values is them checked. The various voltage values may include, for example, VDD, VSS, a data voltage, and a gate voltage.

Next, in operation S2, a pixel 100 is selected for a capacitance measurement. The selected pixel 100 may be an individual pixel disposed in a specific column and a specific row, or may be a plurality of pixels in one or more groups.

In some embodiments, the capacitance may be measured by selecting only the pixels 100 that emit the same color. Since each pixel 100 emitting the same color has an organic emission layer that includes the same material, characteristics of the organic emission layer may be identified. For example, the pixel 100 to be measured may be a blue pixel. In this case, the characteristics of an organic emission layer emitting blue light may be measured and/or evaluated through the measurement of the capacitance of the pixel 100.

Next, in operation S3, a voltage value of the panel driver 30 is set to measure the capacitance of only the selected pixel 100. In this case, the voltage value of the panel driver 30 is set to drive only the selected pixel 100.

In some embodiments, in order to set to drive only the selected pixel 100, the VDD and VSS of the panel driver 30 are constantly maintained and the selected pixel 100 may be allowed to be driven by using only the data voltage and gate signal.

In some embodiments, the data voltage value input to the selected pixel 100 may be set to be lower than a saturation voltage of the driving thin film transistor. This may be performed to reduce or minimize an effect on the measurement of capacitance of the OLED of the selected pixel 100.

Thereafter, in operation S4, the impedance analyzer 40 and first terminal 22 and second terminal 23 of the panel jig are connected. Then, a DC measurement voltage and an AC signal are set.

In some embodiments, the DC measurement voltage may be set to be sequentially changed from about −50 V to about +50 V. In some embodiments, a frequency of the AC signal may be set by selecting a value from a predetermined frequency range, e.g., between about 10 Hz and about 1 GHz. For example, the frequency of the AC signal may be about 100 Hz.

Next, in operation S5, the capacitance according the voltage is measured for the selected pixel 100 while driving the impedance analyzer 40.

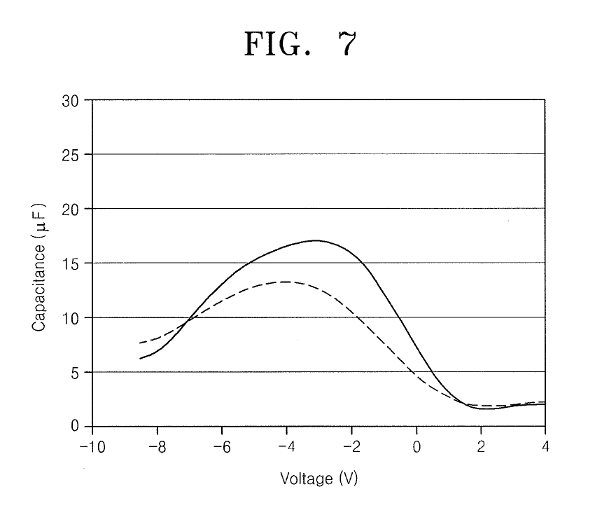

FIG. 7 is a graph illustrating capacitance of an organic light-emitting device according to a DC measurement voltage measured according to the aforementioned method. In FIG. 7, capacitance of the organic light-emitting device is measured by fixing the frequency of the AC signal to about 100 Hz.

Because the capacitance of the organic light-emitting device may be correlated with permittivity, an area, and a distance, the capacitance may vary according to a material deposited on the organic light-emitting device. As a result, capacitance of the organic light-emitting device may be used in comparing changes in the characteristics of the organic light-emitting device, for example, characteristics before and after degradation. In the data of FIG. 7, a solid line represents the capacitance of the organic light-emitting device before the degradation and a dotted line represents the capacitance of the organic light-emitting device after the degradation.

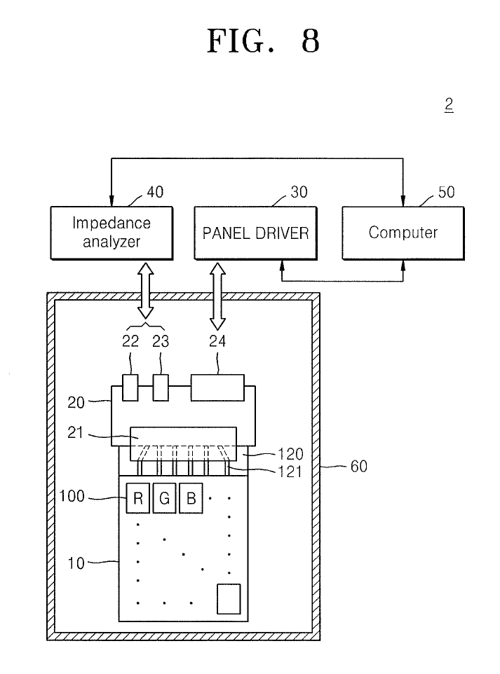

FIG. 8 illustrates another embodiment of an apparatus 2 for measuring capacitance of an organic light-emitting device. Referring to FIG. 8, when compared with apparatus 1, apparatus 2 further includes a temperature control chamber 60.

The temperature control chamber 60 surrounds the display panel 10 and may control the temperature of the display panel 10. The temperature control chamber 60 may measure changes in the characteristics of the display panel 10 according to the effect of temperature. The temperature control chamber 60 may include a heater and/or a cooler to change the temperature of the inside of the temperature control chamber 60. Also, the temperature control chamber 60 may further include a controller that may maintain constant temperature. The characteristics of the organic light-emitting device included in the pixel 100 according to the temperature may be measured and evaluated by using the temperature control chamber 60.

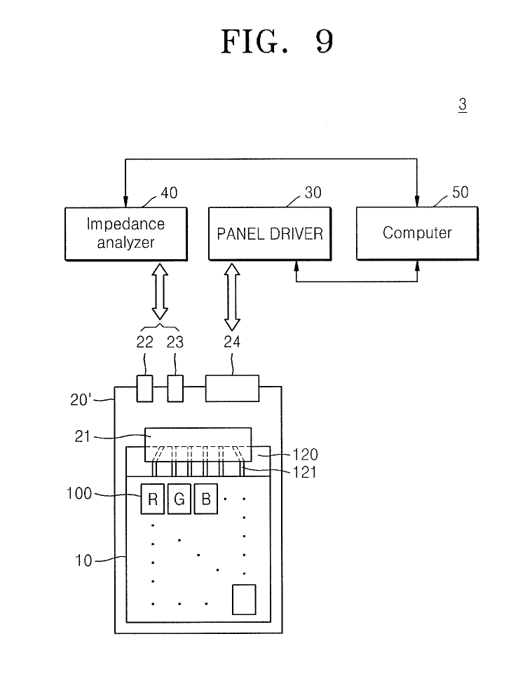

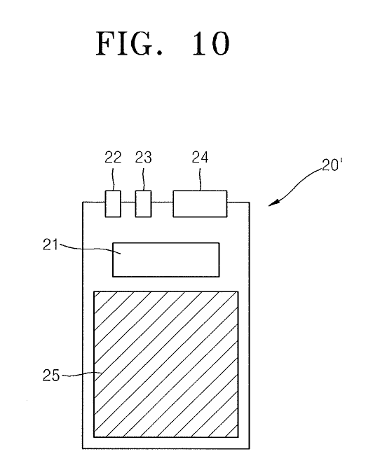

FIG. 9 illustrates another embodiment of an apparatus 3 for measuring capacitance of an organic light-emitting device. FIG. 10 illustrates a plan view of panel jig 20′ of FIG. 9. Referring to FIGS. 9 and 10, when compared with apparatus 1, apparatus 3 further includes a temperature control unit 25 in the panel jig 20′.

The temperature control unit 25 may be disposed under the display panel 10 to change the temperature of the display panel 10. At least one temperature changing device and a controller controlling the temperature changing device may be included in the temperature control unit 25.

In some embodiments, at least one Peltier device and a controller for controlling the Peltier device may be included in the temperature control unit 25. The Peltier device may be formed in such a manner that thermoelectric elements of a semiconductor having N-type impurity ions mixed therein, or a semiconductor having P-type impurity ions mixed therein, are arranged in parallel. Also, electrodes formed of a copper plate may be respectively bonded to top and bottom sides of the thermoelectric elements, and ceramic substrates may be attached to cover the electrodes.

When current is applied to the Peltier device, heat of an upper part of the Peltier device is discharged to a lower part thereof while electrons in the N-type semiconductor and holes in the P-type semiconductor move from the top electrode to the bottom electrode. Thus, a Peltier effect occurs in which the upper part is cooled and the lower part is heated. That is, the Peltier effect is an electric phenomenon where the generation or absorption of heat occurs at a junction between different metals when current is applied.

Therefore, when current is applied to the Peltier device, the temperature changes. The temperature of the temperature control unit 25 may be changed or may be constantly maintained by adjusting the current. The temperature changing device in the temperature control unit 25 is not limited to the Peltier device. For example, various devices may be included in the temperature control unit 25, such as a resistor in which the temperature thereof is changed by the current.

The characteristics of the organic light-emitting device in pixel 100 according to temperature may be measured and evaluated by using the temperature control unit 25.

In accordance with one or more of the aforementioned embodiments, an apparatus for measuring capacitance of an organic light-emitting device may individually or selectively measure capacitances of organic light-emitting devices in a state of a display panel. As a result, characteristics of the organic light-emitting device in the state of the display panel may be easily measured and/or evaluated.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for measuring capacitance of an organic light-emitting device of a display panel having at least one pixel including the organic light-emitting device, the apparatus comprising:
a panel driver to drive the pixel;
an impedance analyzer to measure capacitance of the organic light-emitting device; and
a panel jig to connect the display panel, panel driver, and impedance analyzer.

2. The apparatus as claimed in claim 1, wherein the panel jig includes:
a panel driver connection unit electrically connected to the panel driver;
a flexible printed circuit board electrically connected to a pad electrode of the display panel; and
a first terminal and a second terminal connected to the impedance analyzer.

3. The apparatus as claimed in claim 2, wherein the organic light-emitting device includes a first electrode, an intermediate layer, and a second electrode, and wherein the first terminal is electrically connected to the first electrode and the second terminal is electrically connected to the second electrode.

4. The apparatus as claimed in claim 1, wherein:
the pixel includes a pixel driver and the organic light-emitting device, and
the pixel driver includes at least one thin film transistor.

5. The apparatus as claimed in claim 1, wherein the panel driver includes:
a power driver to provide a high potential voltage and a low potential voltage to the display panel;
a data driver to provide a data voltage to the pixel; and
a gate driver to provide a gate signal to the pixel.

6. The apparatus as claimed in claim 1, wherein the at least one pixel includes a plurality of pixels and wherein the panel driver is to drive the pixels individually or in groups.

7. The apparatus as claimed in claim 1, wherein the panel driver is to select and drive only pixels that emit a same color.

8. The apparatus as claimed in claim 1, wherein a data voltage provided by the panel driver is lower than a saturation voltage of a thin film transistor in the pixel.

9. The apparatus as claimed in claim 1, wherein the impedance analyzer is to measure capacitance by simultaneously applying a direct current (DC) measurement voltage and an alternating current (AC) signal.

10. The apparatus as claimed in claim 1, further comprising:
a temperature control chamber that surrounds the display panel,
wherein the temperature control chamber is to control a temperature of the display panel.

11. The apparatus as claimed in claim 1, wherein the panel jig includes a temperature control unit to control a temperature of the display panel.

12. The apparatus as claimed in claim 11, wherein the temperature control unit includes at least one Peltier device.

13. An apparatus for measuring capacitance of an organic light-emitting device of a display panel including a plurality of pixels, the apparatus comprising:
a panel driver to individually drive the pixels;
an impedance analyzer to measure capacitance of at least one of the pixels; and
a panel jig to connect the display panel, the panel driver, and the impedance analyzer.

14. The apparatus as claimed in claim 13, wherein:
the pixel includes a pixel driver and an organic light-emitting device, and
a cathode terminal and an anode terminal of the organic light-emitting device are connected to the impedance analyzer through the panel jig and a wiring unit of the display panel.

15. The apparatus as claimed in claim 14, wherein:
a first measurement line is connected to the cathode terminal, and
the first measurement line is to provide a predetermined voltage to the pixel.

16. A method of measuring capacitance of an organic light-emitting device in a display panel including a panel driver to drive the pixels, the method comprising:
providing an apparatus including an impedance analyzer to measure capacitance of an organic light-emitting device in at least one of the pixels, and a panel jig to connect the display panel, panel driver, and impedance analyzer;
connecting the display panel, panel driver, impedance analyzer, and panel jig; and
measuring capacitance of the organic light-emitting device by driving the impedance analyzer.

17. The method as claimed in claim 16, wherein measuring the capacitance of the organic light-emitting device includes applying an alternating current (AC) signal while changing a direct current (DC) measurement voltage.

18. The method as claimed in claim 16, wherein a data voltage provided by the panel driver is lower than a saturation voltage of a thin film transistor in the pixel.

19. The method as claimed in claim 16, wherein the capacitance is measured by selecting only pixels that emit a same color.

20. The method as claimed in claim 16, wherein:
the apparatus further includes a temperature control chamber, and
measuring the capacitance of the organic light-emitting device includes changing a temperature of a temperature control chamber in which at least one pixel is included.
